(19) United States
(12) Patent Application Publication
(10) Pub. No.: US 2004/0074154 A1
(43) Pub. Date: Apr. 22, 2004

(54) Insolation regulation device

(76) Inventor: Philippe Mangeard, Nice (FR)

Correspondence Address: YOUNG & THOMPSON, 745 SOUTH 23RD STREET 2ND FLOOR, ARLINGTON, VA, 22202

(21) Appl. No.: 10/471,841

(22) PCT Filed: Mar. 5, 2002
(86) PCT No.: PCT/FR02/00777

(30) Foreign Application Priority Data
Mar. 14, 2001 (FR) 01/03436

(51) Int. Cl. E04B 1/34; B62D 63/04; E04H 15/00; E04H 15/54

(52) U.S. Cl. 52/3; 135/87; 135/115

(57) ABSTRACT

An insolation regulation, modulation and distribution device includes a support structure (1) for a cover for the space to be protected from the sun and control elements for moving the cover periodically in the plane thereof. The cover comprises at least one layer (2) which is provided with at least two types of zones (3, 4) having different light transmission properties, the distribution of which is predetermined.

The present invention relates to a device for the regulation, modulation, distribution of sunlight, comprising a support structure for a cover of a space to be protected from the sun and actuating means for the cover with a periodic movement located in its own plane.

This invention will find particular application in the field of garden, pool or beach accessories and for recreational spaces to provide outdoor furniture.

It could also be used in the field of horticulture, for covering localities such as greenhouses.

The document FR-A-2.747.707 discloses a roof device permitting creating a surface for an adjustable quantity of sunlight and distributing it uniformly, characterized in that it is constituted by a layer of lattice with blades on which slides another layer constituted by one or several lattices with blades, the offset between the lattice being adjustable and the assembly of the lattice being connected to means permitting moving it back and forth.

The roof according to this document has the advantage of distributing the amount of sunlight and to permit adjustment of the width of the passage of the light.

This being the case, it is a roof with a heavy structure constituted by a plurality of blades assembled on a metallic frame.

The power of the motor is thus adjusted to the weight of the assembly.

Although advantageous to constitute an accessory for furniture such as a cover for a veranda or a terrace, the roof according to this document has limits.

It is thus an expensive technique requiring a substantial and relatively powerful motor.

Such an assembly moreover cannot be easily moved.

The present invention permits overcoming the drawbacks of the prior art and proposes for this purpose a new device which has the advantage of obtaining the result of adjusting and distributing the quantity of sunlight whilst constituting a light, transportable, low cost and easily disassembleable assembly.

Moreover, as a result of the lightness of the assembly, the motor will also be substantially less powerful.

Contrary to the prejudice which persists in the field of coverings, particularly for terraces, the present invention uses one or several layers which has the advantage of being light and of providing in a single element the different strips that until now were blades assembled in a lattice.

In addition to the optimization of the weight and the improvement in production, the layers used according to the invention have the advantage of reducing the characteristics of light transmission that need be given to the cover.

Thus, the alternate strips can have variable characteristics of light transmission and not simply be constituted by being totally open or closed to the light.

Thus, the alternate strips could be regions with a textile with a mesh of variable dimension or else regions of transparent plastic material protecting from the rain whilst ensuring the passage of light.

There can be envisaged very numerous variations as to the type of covering of the space to be protected from the sun.

Given its low weight, the invention also has a large freedom in the design of the support, which can for example comprise 1 to 6 feet, according to the needs and the desired appearance.

Other objects and advantages will become apparent from the description which follows, which gives preferred embodiments of the invention which are however not limiting.

The present invention relates to a device for regulating the amount of sunlight, comprising a support structure for a covering of the space to be protected from the sun and means for actuating the cover with a periodic movement in its own plane, characterized by the fact that the cover comprises at least one layer having, according to a predetermined distribution, zones of at least two different types according to their light transmission properties.

The device for regulation can have the following variations:

the distributed zones are parallel and alternating strips of two different types;

the actuating means comprise an eccentric motor connected by a crank to one of the edges of the layer;

the layer is fixed to the structure by elastic connections;

it comprises means for rendering opaque at least a portion of the surface of the zones of one of the types;

the opacification means are a second layer, given the same movement as the first and having, with the same distribution, zones of at least two different types according to their properties of light transmission, the second layer being offset laterally relative to the first;

the second layer is fixed to the first by laterally adjustable securement means.

The accompanying drawings are given by way of indicative example and are not limiting. They show a preferred embodiment according to the invention, they permit easy comprehension of the invention.

FIG. 1 shows the general view of a device according to the invention in a first embodiment.

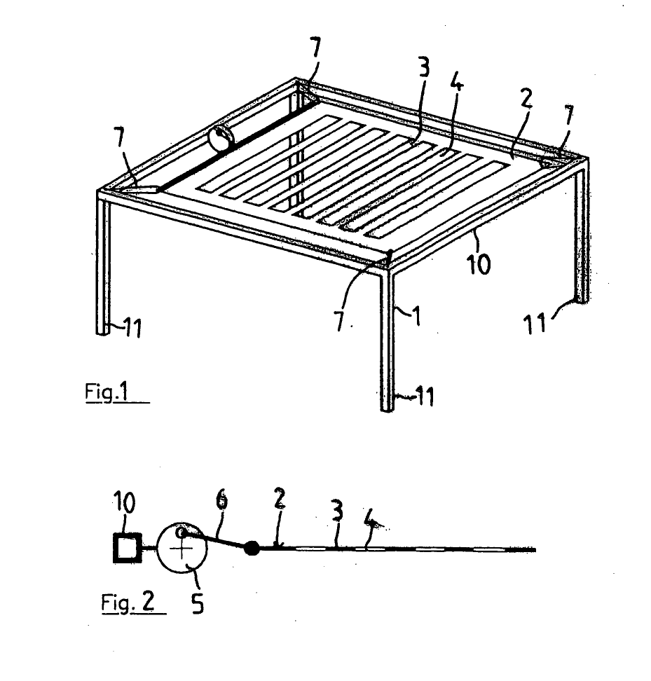

FIG. 2 shows a possibility of actuating means for the cover.

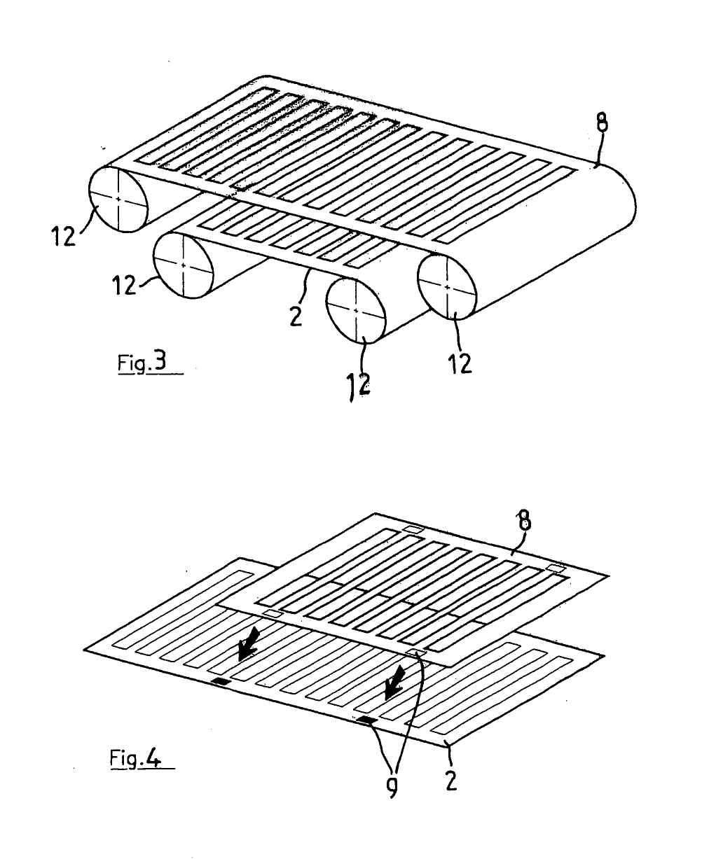

FIG. 3 shows another modified embodiment of the invention.

FIG. 4 shows another possibility for embodiment of the invention.

A first mode for embodiment of the invention is shown in FIG. 1.

In this figure, a support structure 1 is provided to hold the cover in the form of a layer 2.

In the case of this figure, the support structure 1 comprises a frame 10 surrounding the layer 2 whilst several feet 11 provided a vertical upright supporting the frame 10.

In the case of the example, four feet 11 are provided but this possibility is not limiting and there could simply be provided an assembly for example from one or two feet 11 and a frame 10 cantilevered on the one or two feet 11.

The foot or feet 11 are if desired inclinable or comprised by two portions pivoting to modify the inclination of the cover.

Connection means are provided between the frame 10 and the layer 2 whilst still giving it freedom of movement in the plane of the layer 2.

To this end, resilient connection 7 for example constituted by rubber bands could be used.

The resilient deformation of the connection 7 ensures the freedom of movement of the layer 2.

According to a modification, the cover includes a frame for enclosing the layer with which it is secured. It is thus the enclosing frame which is connected by resilient connectors to the frame 10.

Various materials could constitute the layer 2. In particular, a sheet of plastic material can be used as well as a layer of textile material, woven or not.

According to the invention, the layer 2 comprises different regions with different light transmission properties.

In the example of FIG. 1, there are provided zones 3 comprising type A of light transmission characteristics and zones 4 comprising type B of light transmission characteristics.

In the simplest case, the zones 3 are opaque surfaces, preventing any light transmission and the zones 4 are openings provided in the layer 2 and ensuring total transmission of the light rays.

In this simplest case, the zones 4 can be made by simple cutting out in the layer 2 initially constituted by a continuous opaque surface.

That being the case, any variation as to the type of zones 3 and 4 can be envisaged.

For example, the zones 4 can be made of a transparent plastic material ensuring only the passage of light rays without opening the cover to the outside.

According to another possibility, the zones 4 are made of a mesh larger than the zones 3 in a layer of textile material.

Other variations are also to be envisaged without departing from the scope of the invention as to the form and distribution of the zones 3, 4.

Thus, it could be a matter of alternate strips as in the case of FIG. 1 or any other form such as circular holes distributed in a predetermined way.

As indicated above, the construction of the cover by means of a layer 2 has the advantage of providing a lightweight assembly.

A consequence of this light weight is that various possibilities for motor drive are to be envisaged and this with low power.

The actuating means have the function of driving the layer 2 with a movement that takes place substantially in its own plane so as to modify over time the position of the zones 3 and 4 to distribute the amount of sunlight in the space covered by the device.

The movement that is effected can be a back and forth movement by an alternating system but a system rotating about an axis is also to be envisaged.

In the embodiment shown particularly in FIG. 2, the actuating means comprise an eccentric motor 5 whose motor shaft is connected by a crank 6 to one edge of the layer 2.

The case shown in FIG. 1 permits a distribution of the quantity of sunlight (in the covered space) over the course of time.

Preferably, the device according to the invention moreover comprises means for at least partially opacifying the surface of the zones 3, 4 of one of the types A, B.

Thus, according to the intensity of the sunshine or the desires of the user, the properties of light transmission of the cover can be increased or decreased.

To this end, opacification means for a portion of the surface of one of the types A, B of the zones 3, 4 are provided.

FIGS. 3 and 4 show two modified embodiments of opacification means.

In the case of FIG. 3, a second layer 8 is superposed on the layer 2 whilst having zones 3, 4 with the same distribution.

Two layers 2, 8 are thus constituted in a similar and parallel manner, by superposition.

By laterally offsetting the position of the zones 3, 4 of the layer 2 relative to those of the layer 8, there is provided a modification of the properties of light transmission of the assembly.

Thus, if the zones 4 of the layers 2 and 8 are completely confronting, the properties of light transmission will be the maximum, whilst if they are offset by a width corresponding to the width of spacing of two zones 4, the quantity of light transmission will be less.

In the case of FIG. 3, rollers 12 are formed to actuate the layer 2 and the layer 8.

Power driven cylinders permit rolling up and unrolling as desired the two layers 2, 8.

When they operate in a synchronous manner, the layers 2 and 8 permit the spatial distribution of the sunlight.

If one of the layers 2 or 8 is actuated independently of the other, the quantity of sunlight can be adjusted.

Any motor means can be used to drive the rollers 12 in rotation.

FIG. 4 shows another modified embodiment of the opacification means.

In this figure, the layer 8 is connected to the layer 2 and fixed by securement means 9 for example of the type of strips of Velcro (trademark).

Similarly, the layer 8 comprises zones 3, 4 of different types according to a distribution identical to that of layer 2.

During securement of the layer 8 on the layer 2, the lateral offset of the zones 3, 4 of the layer 8 is adjusted relative to that of the layer 2 so as to adjust the desired quantity of sunlight.

Other means of opacification can be provided without departing from the scope of the present invention.

Particularly, withdrawable flaps on zones 4 can be used to pass from a total opacification position to a maximum transmission position.

Moreover, in the case of a layer 2 that can be rolled up on and unrolled from rollers 12, there can be envisaged along the length of the layer several portions having zones 3, 4 with different light transmission properties.

Thus, the width of the zones 3 or 4 can change along the length of the layer 2.

In the course of unrolling the layer, it is possible in this way to cause the light transmission characteristics of the cover to change.

Once these characteristics are predetermined by the user, an alternating back and forth movement of the layer 2 produced by alternate rotation of the rollers 12 will permit the spatial distribution of the sunlight.

### References

1. Support structure

2. Layer

3. Zones A

4. Zones B

5. Eccentric motor

6. Crank

7. Connections

8. Second layer

9. Securement means

10. Frame

11. Feet

12. Rollers

1. Device for adjusting the quantity of sunlight comprising a support structure (1) for a cover for the space to be protected from the sun and means for actuating the cover with a periodic movement in its own plane, characterized by the fact
that the cover comprises at least one layer (2) having, according to a predetermined distribution, zones (3, 4) of at least two different types according to their light transmission properties.

2. Device according to claim 1, characterized by the fact
that the distributed zones (3, 4) are parallel strips and alternating in two different types.

3. Device according to any one of claims 1 or 2, characterized by the fact
that the actuating means comprise an eccentric motor (5) connected by a crank (6) to one of the edges of the layer (2).

4. Device according to any one of claims 1 to 3, characterized by the fact
that the layer (2) is fixed to the structure by resilient connections (7).

5. Device according to any one of claims 1 to 4, characterized by the fact
that it comprises opacification means for at least a portion of the surface of the zones (3, 4) of one of the types.

6. Device according to claim 5, characterized by the fact
that the opacification means are a second layer (8), given the same movement as the first and having, with the same distribution, zones of at least two different types with respect to their light transmission properties, the second layer (8) being offset laterally relative to the first.

7. Device according to claim 6, characterized by the fact
that the second layer (8) is fixed to the first by laterally adjustable securement means.
